(19) United States
(12) Patent Application Publication
(10) Pub. No.: US 2023/0362214 A1
(43) Pub. Date: Nov. 9, 2023

(54) 5G SUPPORT FOR WEBRTC

(71) Applicant: QUALCOMM Incorporated, San Diego, CA (US)

(72) Inventors: Imed Bouazizi, Frisco, TX (US); Liangping Ma, San Diego, CA (US); Nikolai Konrad Leung, San Francisco, CA (US)

(21) Appl. No.: 18/310,128

(22) Filed: May 1, 2023

Related U.S. Application Data
(60) Provisional application No. 63/364,184, filed on May 4, 2022.
(60) Provisional application No. 63/484,568, filed on Feb. 13, 2023.

(51) Int. Cl. H04L 65/1108; H04L 65/1069; H04L 65/1104

(52) U.S. Cl. CPC H04L 65/1108; H04L 65/1069; H04L 65/1104

(57) ABSTRACT

An example device for exchanging media data includes a memory configured to store media data; and one or more processors implemented in circuitry and configured to: execute a media session handler (MSH) to interact with one or more application functions provided by an application provider device, the one or more application functions including one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function; receive a web application from the application provider device; and exchange media data between the one or more application functions provided by the application provider device, the MSH, and the web application.

This application claims the benefit of U.S. Provisional Application No. 63/364,184, filed May 4, 2022, and of U.S. Provisional Application No. 63/484,568, filed Feb. 13, 2023, the entire contents of each of which are hereby incorporated by reference.

### TECHNICAL FIELD

This disclosure relates to storage and transport of encoded video data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques for initiating a Web Real-time Communication (WebRTC) session, e.g., for exchanging media data including audio, image, and/or video data. The WebRTC session may be initiated in a 5G communication system. WebRTC may be used to exchange media data, such as media data for an extended reality (XR) session, which may include an augmented reality (AR), mixed reality (MR), or virtual reality (VR) communication session, including audio and video data along with XR data. A user equipment (UE) involved in the WebRTC session may include a media session handler (MSH) that negotiates with one or more application functions (AFs) of an application server. Furthermore, the UE may retrieve a web application using the MSH from an application provider (AP). The web application may be configured to engage in the XR session, while a native WebRTC application may be configured to send and receive data according to WebRTC via the MSH.

In one example, a device for exchanging media data includes a memory configured to store media data; and one or more processors implemented in circuitry and configured to: execute a media session handler (MSH) to interact with one or more application functions provided by an application provider device; and execute an application to: retrieve configuration information from the MSH related to Web Real-Time Communication (WebRTC); and use the configuration information to establish a WebRTC session and exchange media data via the WebRTC session.

In another example, a method of exchanging media data includes executing a media session handler (MSH) to interact with one or more application functions provided by an application provider device; executing an application to retrieve configuration information from the MSH related to Web Real-Time Communication (WebRTC); and executing the application to use the configuration information to establish a WebRTC session and exchange media data via the WebRTC session.

In another example, a computer-readable storage medium has stored thereon instructions that, when executed, cause a processor to: execute a media session handler (MSH) to interact with one or more application functions provided by an application provider device; execute an application to retrieve configuration information from the MSH related to Web Real-Time Communication (WebRTC); and execute the application to use the configuration information to establish a WebRTC session and exchange media data via the WebRTC session.

In another example, a device for exchanging media data includes means for executing a media session handler (MSH) to interact with one or more application functions provided by an application provider device; means for executing an application to retrieve configuration information from the MSH related to Web Real-Time Communication (WebRTC); and means for exchanging data between the one or more application functions provided by the application provider device, the MSH, and the web application.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating an architecture 100 for a system that may be configured to perform immersive real-time communication for Web Real-Time Communication (WebRTC) (iRTCW) according to techniques of this disclosure.

FIG. 3 is a call flow diagram illustrating an example method for initiating a WebRTC media session according to techniques of this disclosure.

FIG. 4 is a flowchart illustrating an example method of establishing a WebRTC session in a radio access network according to techniques of this disclosure.

### DETAILED DESCRIPTION

In general, this disclosure describes techniques for providing support for Web Real-time Communication (WebRTC) in a radio access network (RAN), such as a 5G network. A user equipment (UE) may send and receive extended reality (XR) data, such as augmented reality (AR) data, mixed reality (MR) data, and/or virtual reality (VR) data, along with audio and/or video data, as part of a WebRTC session. For example, the UE may send user avatar information representing a user's appearance in a virtual scene, pose and/or movement information of the user, actions performed by the user, or the like. The UE may receive audio, video, and/or XR data, e.g., based on the pose, movement, and interactions of the user with the virtual scene, as well as based on other participants in the WebRTC session. Thus, multiple UEs may be involved in the WebRTC session, e.g., for a virtual teleconference in a virtual scene, a video game, or other such scenarios.

In accordance with the techniques of this disclosure, the UE may include a media session handler (MSH) and a native WebRTC application. The WebRTC application may be configured to send and receive WebRTC session data via the MSH, while the MSH may send and receive data using one or more application functions (AFs) of a trusted RTC AF server. To determine the RTC AF server, the MSH may initially perform interactive connectivity establishment (ICE) negotiation. ICE negotiation may generally involve retrieving a list of ICE candidates and selecting one of the ICE candidates to be used for the WebRTC session. The ICE candidates may be, for example, Session Traversal Utilities for Network Address Translation (STUN) and/or Traversal Using Relay around NAT (TURN) server candidates that offer 5G RTC functionality. The MSH may also retrieve media configuration recommendations. The MSH may provide the data representing the ICE candidates and media configuration recommendations to the web application.

The web application, in turn, may construct a request (or a response to a request) for a WebRTC session and send the request to one of the ICE candidates. After the one of the ICE candidates validates the request, the UE may receive one binding information and quality of service (QoS) and codec recommendations from the one of the ICE candidates. The application of the UE may then update a session description protocol (SDP) offer or answer based on the information received from the ICE candidates and use the updated SDP offer/answer to establish the WebRTC media session, e.g., with one or more other UEs and/or a media server.

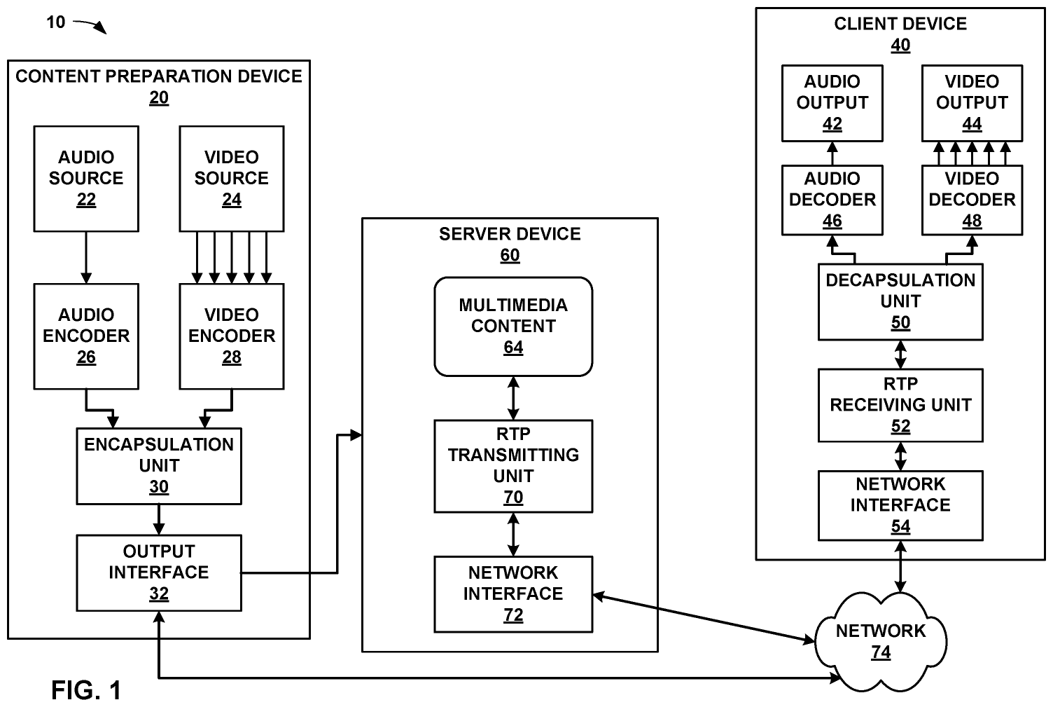

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a media presentation. For example, the coded video or audio part of the media presentation can be an elementary stream. An elementary stream may be converted into a packetized elementary stream (PES) before being encapsulated within a video file. Within the same media presentation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into streamable media data.

Encapsulation unit 30 receives PES packets for elementary streams of a media presentation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points.

Server device 60 includes Real-time Transport Protocol (RTP) transmitting unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64 and include components that conform substantially to those of server device 60. In general, network interface 72 is configured to send and receive data via network 74.

RTP transmitting unit 70 is configured to deliver media data to client device 40 via network 74 according to RTP, which is standardized in Request for Comment (RFC) 3550 by the Internet Engineering Task Force (IETF). RTP transmitting unit 70 may also implement protocols related to RTP, such as RTP Control Protocol (RTCP), Real-time Streaming Protocol (RTSP), Session Initiation Protocol (SIP), and/or Session Description Protocol (SDP). RTP transmitting unit 70 may send media data via network interface 72, which may implement Uniform Datagram Protocol (UDP) and/or Internet protocol (IP). Thus, in some examples, server device 60 may send media data via RTP and RTSP over UDP using network 74.

RTP transmitting unit 70 may receive an RTSP describe request from, e.g., client device 40. The RTSP describe request may include data indicating what types of data are supported by client device 40. RTP transmitting unit 70 may respond to client device 40 with data indicating media streams, such as media content 64, that can be sent to client device 40, along with a corresponding network location identifier, such as a uniform resource locator (URL) or uniform resource name (URN).

RTP transmitting unit 70 may then receive an RTSP setup request from client device 40. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on client device 40. RTP transmitting unit 70 may reply to the RTSP setup request with a confirmation and data representing ports of server device 60 by which the RTP data and control data will be sent. RTP transmitting unit 70 may then receive an RTSP play request, to cause the media stream to be “played,” i.e., sent to client device 40 via network 74. RTP transmitting unit 70 may also receive an RTSP teardown request to end the streaming session, in response to which, RTP transmitting unit 70 may stop sending media data to client device 40 for the corresponding session.

RTP receiving unit 52, likewise, may initiate a media stream by initially sending an RTSP describe request to server device 60. The RTSP describe request may indicate types of data supported by client device 40. RTP receiving unit 52 may then receive a reply from server device 60 specifying available media streams, such as media content 64, that can be sent to client device 40, along with a corresponding network location identifier, such as a uniform resource locator (URL) or uniform resource name (URN).

RTP receiving unit 52 may then generate an RTSP setup request and send the RTSP setup request to server device 60. As noted above, the RTSP setup request may contain the network location identifier for the requested media data (e.g., media content 64) and a transport specifier, such as local ports for receiving RTP data and control data (e.g., RTCP data) on client device 40. In response, RTP receiving unit 52 may receive a confirmation from server device 60, including ports of server device 60 that server device 60 will use to send media data and control data.

After establishing a media streaming session between server device 60 and client device 40, RTP transmitting unit 70 of server device 60 may send media data (e.g., packets of media data) to client device 40 according to the media streaming session. Server device 60 and client device 40 may exchange control data (e.g., RTCP data) indicating, for example, reception statistics by client device 40, such that server device 60 can perform congestion control or otherwise diagnose and address transmission faults.

Network interface 54 may receive and provide media of a selected media presentation to RTP receiving unit 52, which may in turn provide the media data to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, RTP receiving unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, RTP receiving unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via RTP receiving unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

The techniques described above are describe with respect to RTP for purposes of example. However, the techniques of this disclosure may use other protocols for transporting media data, such as HTTP streaming-based protocols, e.g., Dynamic Adaptive Streaming over HTTP (DASH) or HTTP Live Streaming (HLS). In HTTP streaming, such as Dynamic Adaptive Streaming over HTTP (DASH), frequently used operations include HEAD, GET, and partial GET. The HEAD operation retrieves a header of a file associated with a given uniform resource locator (URL) or uniform resource name (URN), without retrieving a payload associated with the URL or URN. The GET operation retrieves a whole file associated with a given URL or URN. The partial GET operation receives a byte range as an input parameter and retrieves a continuous number of bytes of a file, where the number of bytes correspond to the received byte range. Thus, movie fragments may be provided for HTTP streaming, because a partial GET operation can get one or more individual movie fragments. In a movie fragment, there can be several track fragments of different tracks. In HTTP streaming, a media presentation may be a structured collection of data that is accessible to the client. The client may request and download media data information to present a streaming service to a user.

In the example of streaming 3GPP data using HTTP streaming, there may be multiple representations for video and/or audio data of multimedia content. As explained below, different representations may correspond to different coding characteristics (e.g., different profiles or levels of a video coding standard), different coding standards or extensions of coding standards (such as multiview and/or scalable extensions), or different bitrates. The manifest of such representations may be defined in a Media Presentation Description (MPD) data structure. A media presentation may correspond to a structured collection of data that is accessible to an HTTP streaming client device. The HTTP streaming client device may request and download media data information to present a streaming service to a user of the client device. A media presentation may be described in the MPD data structure, which may include updates of the MPD.

A media presentation may contain a sequence of one or more Periods. Each period may extend until the start of the next Period, or until the end of the media presentation, in the case of the last period. Each period may contain one or more representations for the same media content. A representation may be one of a number of alternative encoded versions of audio, video, timed text, or other such data. The representations may differ by encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular period may be assigned to a group indicated by an attribute in the MPD indicative of an adaptation set to which the representations belong. Representations in the same adaptation set are generally considered alternatives to each other, in that a client device can dynamically and seamlessly switch between these representations, e.g., to perform bandwidth adaptation. For example, each representation of video data for a particular period may be assigned to the same adaptation set, such that any of the representations may be selected for decoding to present media data, such as video data or audio data, of the multimedia content for the corresponding period. The media content within one period may be represented by either one representation from group 0, if present, or the combination of at most one representation from each non-zero group, in some examples. Timing data for each representation of a period may be expressed relative to the start time of the period.

A representation may include one or more segments. Each representation may include an initialization segment, or each segment of a representation may be self-initializing. When present, the initialization segment may contain initialization information for accessing the representation. In general, the initialization segment does not contain media data. A segment may be uniquely referenced by an identifier, such as a uniform resource locator (URL), uniform resource name (URN), or uniform resource identifier (URI). The MPD may provide the identifiers for each segment. In some examples, the MPD may also provide byte ranges in the form of a range attribute, which may correspond to the data for a segment within a file accessible by the URL, URN, or URI.

Different representations may be selected for substantially simultaneous retrieval for different types of media data. For example, a client device may select an audio representation, a video representation, and a timed text representation from which to retrieve segments. In some examples, the client device may select particular adaptation sets for performing bandwidth adaptation. That is, the client device may select an adaptation set including video representations, an adaptation set including audio representations, and/or an adaptation set including timed text. Alternatively, the client device may select adaptation sets for certain types of media (e.g., video), and directly select representations for other types of media (e.g., audio and/or timed text).

When performing HTTP streaming, client device 40 may determine configuration data representing decoding capabilities of video decoder 48 and rendering capabilities of video output 44. The configuration data may also include any or all of a language preference selected by a user of client device 40, one or more camera perspectives corresponding to depth preferences set by the user of client device 40, and/or a rating preference selected by the user of client device 40. Client device 40 may comprise, for example, a web browser or a media client configured to submit HTTP GET and partial GET requests. Client device 40 may include software instructions executed by one or more processors or processing units (not shown) of client device 40. In some examples, all or portions of the functionality described with respect to client device 40 may be implemented in hardware, or a combination of hardware, software, and/or firmware, where requisite hardware may be provided to execute instructions for software or firmware.

Client device 40 may compare the decoding and rendering capabilities of client device 40 to characteristics of representations 68 indicated by information of manifest file 66. Client device 40 may initially retrieve at least a portion of manifest file 66 to determine characteristics of representations 68. For example, client device 40 may request a portion of manifest file 66 that describes characteristics of one or more adaptation sets. Client device 40 may select a subset of representations 68 (e.g., an adaptation set) having characteristics that can be satisfied by the coding and rendering capabilities of client device 40. Client device 40 may then determine bitrates for representations in the adaptation set, determine a currently available amount of network bandwidth, and retrieve segments from one of the representations having a bitrate that can be satisfied by the network bandwidth.

In general, higher bitrate representations may yield higher quality video playback, while lower bitrate representations may provide sufficient quality video playback when available network bandwidth decreases. Accordingly, when available network bandwidth is relatively high, client device 40 may retrieve data from relatively high bitrate representations, whereas when available network bandwidth is low, client device 40 may retrieve data from relatively low bitrate representations. In this manner, client device 40 may stream multimedia data over network 74 while also adapting to changing network bandwidth availability of network 74.

Additionally or alternatively, client device 40 may be configured to receive data in accordance with a broadcast or multicast network protocol, such as eMBMS or IP multicast. In such examples, client device 40 may submit a request to join a multicast network group associated with particular media content. After joining the multicast group, client device 40 may receive data of the multicast group without further requests issued to server device 60 or content preparation device 20. Client device 40 may submit a request to leave the multicast group when data of the multicast group is no longer needed, e.g., to stop playback or to change channels to a different multicast group.

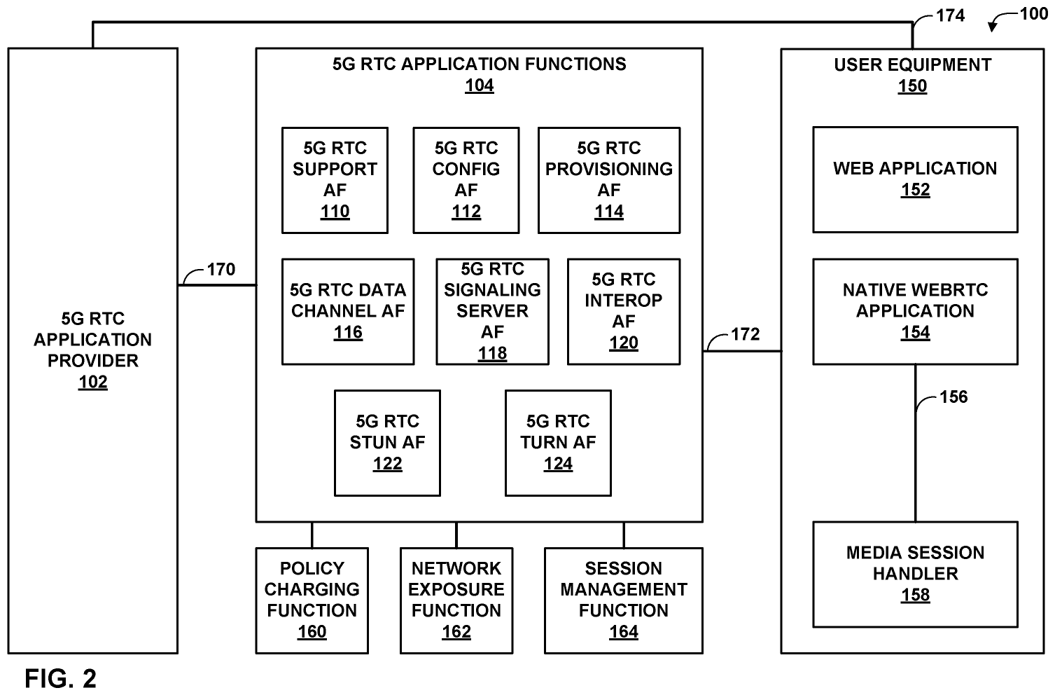

FIG. 2 is a block diagram illustrating an architecture 100 for a system that may be configured to perform immersive real-time communication for Web Real-Time Communication (WebRTC) (iRTCW) according to techniques of this disclosure. In particular, architecture 100 may be used for 5G media streaming (5GMS) using WebRTC. That is, architecture 100 may be used to perform WebRTC real time communication over a 5G network connection.

Architecture 100 may be used to provide WebRTC in a variety of scenarios. As one example, architecture 100 may be used in conjunction with a 5G network to provide “over the top” (OOT) WebRTC. As another example, a mobile network operator (MNO) may provide trusted WebRTC functions and/or facility WebRTC services using architecture 100. As still another example, architecture 100 may provide inter-operable WebRTC services. Architecture 100 may also be used for various other scenarios as well. Architecture 100 provides flexibility through a set of functions and interfaces that can be combined in different ways based on the needs for a particular scenario.

In the example of FIG. 2, architecture 100 includes 5G RTC application provider 102, 5G RTC application functions 104, and user equipment (UE) 150. In general, 5G RTC application provider 102 interacts with functions of 5G RTC application functions 104 and supplies a 5G RTC-aware application, such as web application 152, to user equipment 150.

User equipment 150 may also be referred to as “UE” or a “client device.” UE 150 may correspond to client device 40 of FIG. 1. User equipment 150 may be, for example, a laptop or desktop computer, a digital camera, a digital recording device, a digital media player, a video gaming device, a video game console, a cellular or satellite radio telephone, a video teleconferencing device, or the like. In this example, user equipment 150 includes web application 152, native WebRTC application 154, and media session handler (MSH) 158. Web application 152, native WebRTC application 154, and MSH 156 may correspond to RTP receiving unit 52 of FIG. 1. Interface 156 couples native WebRTC application 154 and MSH 158. Interface 156 may be referred to as an “RTC-6” interface. UE 150 and 5G RTC application provider 102 are coupled by interface 174, which may be referred to as an “RTC-8” interface.

MSH 158 is a function in UE 150 that provides WebRTC applications, such as web application 152, access to 5G RTC support functions, such as 5G RTC application functions 104. These functions may be offered on request through the interface 156 (the RTC-6 interface) or transparently without direct involvement of web application 154. MSH 158 may, for instance, assist indirectly in interactive connectivity establishment (ICE) negotiation by providing a list of Session Traversal Utilities for Network Address Translation (STUN) and/or Traversal Using Relay around NAT (TURN) server candidates that offer 5G RTC functionality. MSH 158 may also collect quality of experience (QoE) metric reports and submit consumption reports. MSH 158 may also offer media configuration recommendations to web application 152 through interface 156 (RTC-6).

According to “3rd Generation Partnership Project; Technical Specification Group Services and System Aspects; 5G Media Streaming (5GMS); Protocols,” (Release 17) TS 26.512, (March 2022), the media session handler of a UE maintains internal properties as follows:

TABLE 12.2.2.2-1
Parameters of Media Session Handler

| States and Parameters | Definition |
|---|---|
| _Configuration | |
| _networkAssistance | Network Assistance configuration. |
| _policyTemplate | Policy Template configuration. |
| _consumptionReporting | Consumption reporting configuration. |
| _metricsReporting | Metrics reporting configuration. |
| _status[ ] | The Media Session Handler maintains a status |
| | record. |

MSH 158 may be started when native WebRTC application 154 makes a call to a media presentation description (MPD) URL. During a WebRTC session, MSH 158 may send consumption reports to, e.g., 5G RTC application provider 102. The consumption reports may generally indicate content that has been consumed by UE 150. The network assistance configuration may represent bit rate recommendations and delivery boosts from 5G RTC AFs 104. The policy template configuration may represent one or more policies select from a set of policy templates configured during a provisioning session. The metric reporting configuration may represent metrics reports to be delivered to 5G RTC AFs 104, e.g., contents of the metrics reports, frequency of delivery of the metrics reports, or the like.

Interface 170 (which may be referred to as an “RTC-1” interface) allows 5G RTC application provider 102 to provision support for offered RTC sessions as 5G RTC application functions 104. The provisioning may cover functionalities including quality of service (QoS) for WebRTC sessions, charging provisioning for WebRTC sessions, collection of consumption and QoE metrics data related to WebRTC sessions, offering ICE functionality, such as STUN and TURN servers, and/or offering WebRTC signaling servers, potentially with interoperability to other signaling servers.

In this example, 5G RTC application functions 104 include 5G RTC support application function (AF) 110, 5G RTC configuration (config) AF 112, 5G RTC provisioning AF 114, 5G RTC data channel AF 116, 5G RTC signaling server AF 118, 5G RTC interoperability (interop) AF 120, 5G RTC STUN AF 122, and 5G RTC TURN AF 124. In this example, 5G RTC application functions 104 are also interoperable with policy and charging function (PCF) 160, network exposure function (NEF) 162, and session management function (SMF) 164.

Interface 170, which may be referred to as a “provisioning interface,” is not necessarily relevant to all collaboration scenarios, and some of the 5G support functionality may be offered without application provider provisioning.

Interface 172 (which may be referred to as an “RTC-5” interface) is an interface between MSH 158 and 5G RTC application functions 104. Interface 172 may be used to convey configuration information from 5G RTC application functions 104 to MSH 158 and to request support for a starting/ongoing WebRTC session. The configuration information may include static information such as recommendations for media configurations, configurations of STUN and TURN server locations, configuration about consumption and QoE reporting, or discovery information for WebRTC signaling and data channel servers and their capabilities.

MSH 158 may provide support functionality such as informing 5G RTC application functions 104 or web application 152 about a WebRTC session and its state, requesting QoS allocation for a starting or modified WebRTC session, receiving a notification about changes to the QoS allocation for an ongoing WebRTC session, or receiving, updating, or exchanging information about the WebRTC session with the 5G RTC STUN/TURN/Signaling Server, e.g., to identify a WebRTC session and associate it with a QoS template.

In some examples, the 5G functionality that offer application functions to the WebRTC application (including 5G RTC data channel AF 116, 5G RTC signaling server AF 118, 5G RTC interop AF 120, 5G RTC STUN AF 122, and 5G RTC TURN AF 124) may instead be provided by Application Servers (5G RTC AS) instead of AFs. The 5G RTC AS could then use a dedicated RTC-3 interface to request configurations and network support for the ongoing WebRTC sessions from the 5G RTC AF.

Functionality attributed to 5G RTC application provider 102, 5G RTC application functions 104, and UE 150 may be implemented in hardware, software, firmware, or any combination thereof. When implemented in software or firmware, memory may be provided for storing instructions that may be executed by one or more processors implemented in circuitry. Processors may include one or more of microprocessors, digital signal processors (DSPs), application specific integrated circuits (ASICs), field programmable gate arrays (FPGAs), discrete logic circuitry, or any combinations thereof.

In this manner, UE 150 represents an example of a device for exchanging media data including: a memory configured to store media data; and one or more processors implemented in circuitry and configured to: execute a media session handler (MSH) to interact with one or more application functions provided by an application provider device, the one or more application functions including one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function; receive a web application from the application provider device; and exchange media data between the one or more application functions provided by the application provider device, the MSH, and the web application.

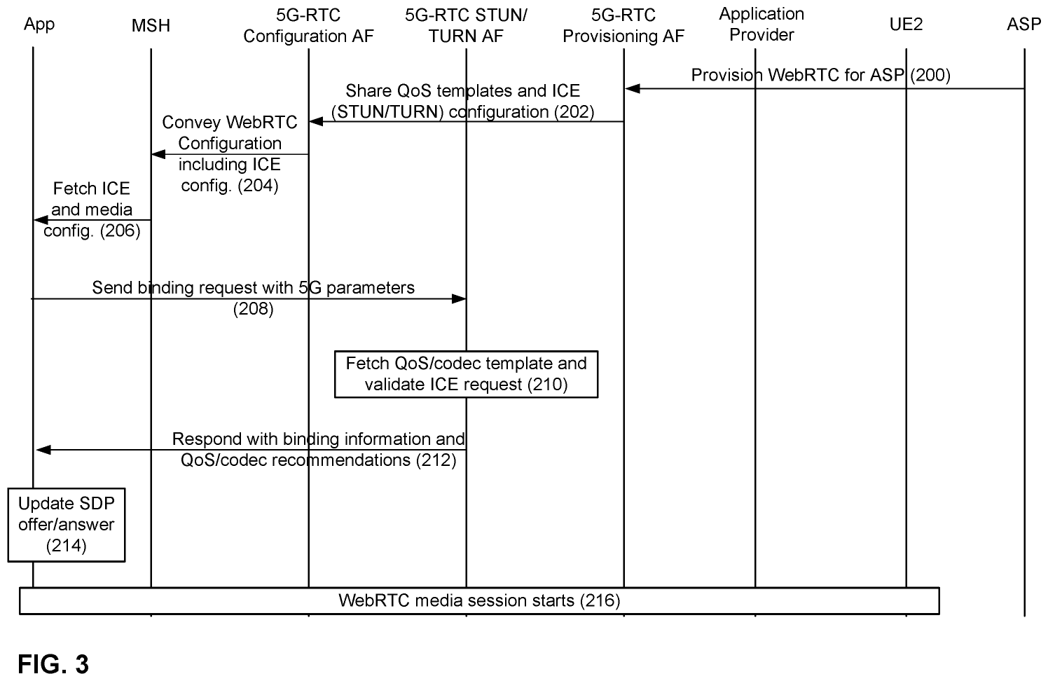

FIG. 3 is a call flow diagram illustrating an example method for initiating a WebRTC media session according to techniques of this disclosure. In some examples, a 5G system for WebRTC sessions may offer integrated support through offering 5G RTC STUN functionality.

A 5G RTC STUN AF is a STUN server (compatible with RFC8489). In addition, the 5G RTC STUN AF server offers 5G functionality to support a WebRTC session. The STUN server receives bind requests as part of the ICE negotiation. These requests allow the STUN server to discover the public IP address and port number of the connection, the so-called reflexive transport address. The request and response may contain STUN attributes, which can be marked as comprehension-required or comprehension-optional. A STUN server that is not configured to interpret a comprehension-required attribute may reply with an error message. IANA maintains a registry of the STUN attributes.

This disclosure describes additional STUN attributes that may be used to trigger 5G support for a WebRTC application. These attributes may allow the 5G RTC STUN server to request, for example, QoS allocation and charging for the media connection. The following attributes are examples of additional STUN attributes, which may be comprehension-optional attributes: 3GPP-PRIVATE-ADDRESS: a protocol family indicator, an IP address, and a port number that correspond to the private transport address as seen by the UE; 3GPP-QOS: an indication of the QoS attributes that are associated with the connection associated with this request, which may include an average bitrate, a max bitrate, a max latency, and a max packet loss rate (PLR) indicator; and 3GPP-CODEC: represents the codec mime type and the codec parameter that describes the codec to be used for this connection, and multiple values may be provided.

A 5G RTC STUN server may support these attributes. The 5G RTC STUN server may use the information in a successful binding to request QoS allocation and charging policy. The 5G RTC STUN may also respond with a recommendation about the target QoS parameters and/or a recommended codec using the STUN attributes.

With respect to the example of FIG. 3, an application service provider (ASP) (e.g., 5G RTC application provider 102 of FIG. 2) that offers better 5G support for its WebRTC-based applications creates a provisioning session with 5G RTC Provisioning AF 114 (200). This step is optional and the mobile network operator (MNO) may decide to offer support for WebRTC sessions without an associated provisioning session.

5G RTC Provisioning AF 114 may then share the QoS and media configuration templates with all associated 5G RTC AFs 104 (202). This can, for example, be done through storing this information in a unified data management function (UDF).

5G RTC configuration AF 112 may then send the WebRTC configuration, including the STUN and TURN server list, to MSH 158 as part of service access information (204).

Web application 152 may fetch the list of pre-configured STUN and TURN servers from local configuration (206), e.g., via MSH 158. The configuration may indicate, for each server, if the server is 5G RTC enabled.

Web application 152 may then submit a binding request to 5G RTC STUN AF 122 server with the additional attributes to trigger ICE negotiation (208).

5G RTC STUN AF 122 retrieves the associated QoS template and media configuration (210).

5G RTC STUN AF 122 creates a binding response and sends the additional information back to web application 152 together with the address binding (212).

Web application 152 updates the offer/answer session description protocol (SDP) based on the received STUN information (214). The WebRTC media session may then begin (216). That is, web application 152 may send and/or receive media data via the WebRTC media session.

To configure the WebRTC session, MSH 158 may receive a list of 5G RTC STUN and TURN servers that are provided by the MNO for 5G system integration of WebRTC sessions. MSH 158 may also receive recommendations about the QoS templates for WebRTC sessions. The MSH makes this information available to web application 152 through interface 156, i.e., the RTC-6 interface.

The information may be formatted as follows:

| Name | Type | Description |
|---|---|---|
| ice_af_list | array | A list of ICE AFs that an application |
| | (Object) | may use for the ICE negotiation. |
| type | enumeration | the type of the ICE server, which |
| | | may either be STUN or TURN. |
| url | string | the URL of the ICE server. |
| 5g_enabled | boolean | indicates if the current ICE server is |
| | | 5G RTC enabled. A 5G RTC ICE |
| | | server supports the STUN attributes |
| | | and is able to perform tasks such as |
| | | QoS allocation. |
| media_recom- | array | A list of media configuration |
| mendations | (Object) | recommendations that the |
| | | application should use to create its |
| | | offer/answer. |
| type | enumeration | indicates the media type, which can |
| | | be AUDIO, VIDEO, TEXT. |
| codec | string | the recommended codec |
| | | configuration for the media type |
| average_bitrate | integer | the recommended average bitrate |
| max_bitrate | integer | the recommended peak bitrate |

For web applications, such as web application 152, the configuration information may be accessible through standardized W3C APIs such as the Indexed Database API or the File API.

The 5G RTC STUN server may use N5 or N33 interfaces to request QoS allocation for the associated STUN binding. Upon determining the 3-Tuple for the connection (public IP address, port number, and protocol), the 5G RTC STUN server may invoke the Nnef_AFsessionWithQoS or the Npcf_PolicyAuthorization methods to request QoS for the identified QoS flow.

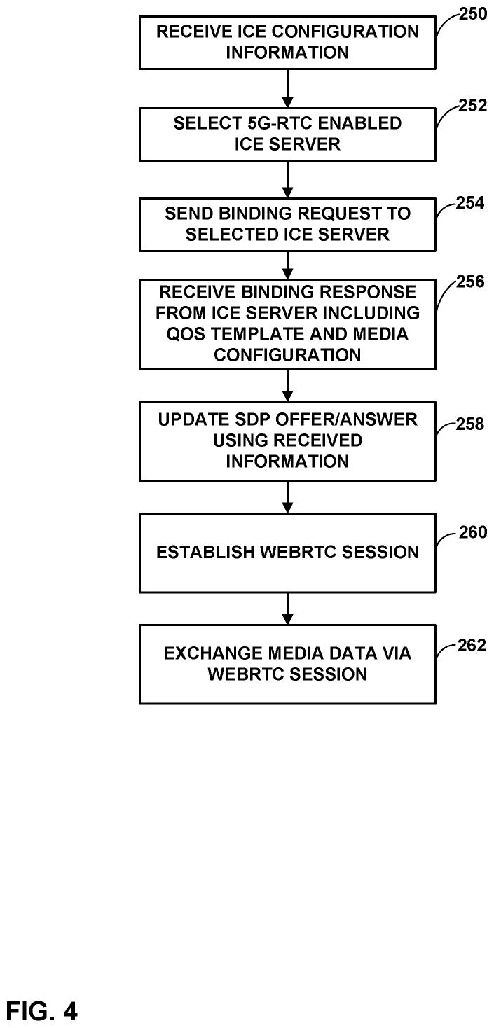

FIG. 4 is a flowchart illustrating an example method of establishing a WebRTC session in a radio access network according to techniques of this disclosure. The method of FIG. 4 is explained with respect to UE 150 of FIG. 2. However, other devices, such as client device 40 of FIG. 1, may perform this or a similar method.

As discussed above, UE 150 may execute MSH 158 to interact with one or more application functions, such as RTC AFs 140 of FIG. 2. UE 150 may also execute native WebRTC application 154 to perform WebRTC operations, e.g., sending and receiving media data via a WebRTC session. In particular, UE 150 may execute MSH 158 to receive interactive connectivity establishment (ICE) configuration information for a WebRTC session (250). The ICE configuration information may include a list of ICE candidates, and for each of the ICE candidates, a type for the ICE candidate (e.g., STUN or TURN), a URL for accessing the ICE candidate, and an indication of whether the ICE candidate is 5G enabled.

Using the received ICE configuration information, MSH 158 may select one of the 5G RTC enabled ICE candidates (252). MSH 158 may then send a binding request to the selected ICE candidate (254). The binding request may include additional attributes to trigger ICE negotiation. The attributes may include, for example, 3GPP private address data including a protocol family indicator, an IP address, and a port number that corresponds to the private transport address as seen by UE 150. The attributes may also include 3GPP Quality of Service (QoS) data indicating QoS attributes that are associated with a connection associated with a request. The QoS attributes may include an average bitrate, a maximum bitrate, a maximum latency, and a packet loss rate (PLR) indication. The attributes may further include 3GPP codec data indicating one or more CODEC mime types and codec parameter(s) that describe the codec(s) to be used for this connection.

MSH 158 may then receive a binding response from the ICE candidate, where the binding response incudes a QoS template and media configuration data (256). The media configuration data may include a list of media configuration recommendations and, for each media recommendation, a type (e.g., whether the media is audio, video, text, or the like), a codec configuration for the media, a recommended average bitrate for the media, and a recommended peak or maximum bitrate for the media. MSH 158 may then update a session description offer or answer using the received information (258) and establish a WebRTC session (260). Web application 152 may then participate in a virtual scene, sending and receiving application-layer data via native WebRTC application 154, which may encapsulate and decapsulate WebRTC data into various formats for web application 152. In this manner, web application 152 may exchange media data via the WebRTC session (262).

Accordingly, the method of FIG. 4 represents an example of a method including executing a media session handler (MSH) to interact with one or more application functions provided by an application provider device, the one or more application functions including one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function; receiving a web application from the application provider device; and exchanging data between the one or more application functions provided by the application provider device, the MSH, and the web application.

Examples of certain techniques of this disclosure are summarized in the following clauses:

Clause 1: A device for retrieving media data, the device comprising: a memory configured to store media data; and one or more processors implemented in circuitry and configured to: execute a media session handler (MSH) to interact with one or more application functions provided by an application provider device, the one or more application functions including one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function; receive a web application from the application provider device; and exchange data between the one or more application functions provided by the application provider device, the MSH, and the web application.

Clause 2: The device of clause 1, wherein the one or more processors are further configured to participate in a Web Real Time Communication (WebRTC) session using the one or more application functions to send or receive the media data via the WebRTC session.

Clause 3: The device of any of clauses 1 and 2, wherein the one or more application functions further include one or more of a policy charging function, a network exposure function, or a session management function.

Clause 4: The device of any of clauses 1-3, wherein the one or more processors are further configured to: receive WebRTC configuration data from a configuration application function; determine interactive connectivity establishment (ICE) and media configuration parameters from the WebRTC configuration data; submit a binding request to a Session Traversal Utilities for Network Address Translation (STUN) server using the ICE and media configuration parameters; receive binding information in response to the binding request including quality of service (QoS) and codec data; update a session description protocol (SDP) offer or answer according to the received binding information; and initiate a WebRTC media session according to the updated SDP offer or answer.

Clause 5: An application provider device comprising: a memory configured to store media data; and one or more processors implemented in circuitry and configured to: provide one or more application functions, the one or more application functions including one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function; provide a web application to a user equipment (UE) device; and exchange data between the one or more application functions and the UE device.

Clause 6: The application provider device of clause 5, wherein the one or more processors are further configured to participate in a Web Real Time Communication (WebRTC) session using the one or more application functions to send or receive the media data via the WebRTC session.

Clause 7: The device of any of clauses 5 and 6, wherein the one or more application functions further include one or more of a policy charging function, a network exposure function, or a session management function.

Clause 8: The application provider device of any of clauses 5-7, wherein the one or more processors are further configured to: share one or more quality of service (QoS) templates and Session Traversal Utilities for Network Address Translation (STUN) server configuration data; send WebRTC configuration data according to the QoS templates and STUN server configuration data to the UE device; receive a binding request with configuration parameters from the UE device; validate the binding request using the QoS templates and STUN server configuration data; and send binding information including QoS and codec recommendations to the client device to initiate a WebRTC session.

Clause 9: A method of retrieving media data, the method comprising: executing a media session handler (MSH) to interact with one or more application functions provided by an application provider device, the one or more application functions including one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function; receiving a web application from the application provider device; and exchanging data between the one or more application functions provided by the application provider device, the MSH, and the web application.

Clause 10: The method of clause 9, further comprising participating in a Web Real Time Communication (WebRTC) session using the one or more application functions to send or receive the media data via the WebRTC session.

Clause 11: The method of any of clauses 9 and 10, wherein the one or more application functions further include one or more of a policy charging function, a network exposure function, or a session management function.

Clause 12: The method of any of clauses 9-11, further comprising: receiving WebRTC configuration data from a configuration application function; determining interactive connectivity establishment (ICE) and media configuration parameters from the WebRTC configuration data; submitting a binding request to a Session Traversal Utilities for Network Address Translation (STUN) server using the ICE and media configuration parameters; receiving binding information in response to the binding request including quality of service (QoS) and codec data; updating a session description protocol (SDP) offer or answer according to the received binding information; and initiating a WebRTC media session according to the updated SDP offer or answer.

Clause 13: A method comprising: providing one or more application functions, the one or more application functions including one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function; providing a web application to a user equipment (UE) device; and exchanging data between the one or more application functions and the UE device.

Clause 14: The method of clause 13, further comprising participating in a Web Real Time Communication (WebRTC) session using the one or more application functions to send or receive the media data via the WebRTC session.

Clause 15: The method of any of clauses 13 and 14, wherein the one or more application functions further include one or more of a policy charging function, a network exposure function, or a session management function.

Clause 16: The method of any of clauses 13-15, further comprising: sharing one or more quality of service (QoS) templates and Session Traversal Utilities for Network Address Translation (STUN) server configuration data; sending WebRTC configuration data according to the QoS templates and STUN server configuration data to the UE device; receiving a binding request with configuration parameters from the UE device; validating the binding request using the QoS templates and STUN server configuration data; and sending binding information including QoS and codec recommendations to the client device to initiate a WebRTC session.

Clause 17: A computer-readable storage medium having stored thereon instructions that, when executed, cause a processor to perform the method of any of clauses 9-16.

Clause 18: A device comprising: means for executing a media session handler (MSH) to interact with one or more application functions provided by an application provider device, the one or more application functions including one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function; means for receiving a web application from the application provider device; and means for exchanging data between the one or more application functions provided by the application provider device, the MSH, and the web application.

Clause 19: A device comprising: means for providing one or more application functions, the one or more application functions including one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function; means for providing a web application to a user equipment (UE) device; and means for exchanging data between the one or more application functions and the UE device.

Clause 20: A device for exchanging media data, the device comprising: a memory configured to store media data; and one or more processors implemented in circuitry and configured to: execute a media session handler (MSH) to interact with one or more application functions provided by an application provider device, the one or more application functions including one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function; receive a web application from the application provider device; and exchange media data between the one or more application functions provided by the application provider device, the MSH, and the web application.

Clause 21: The device of clause 20, wherein to exchange the media data between the one or more application functions, the MSH, and the web application, the one or more processors are configured to send or receive the media data via a Web Real Time Communication (WebRTC) session with the one or more application functions.

Clause 22: The device of any of clauses 20 and 21, wherein the one or more application functions further include one or more of a policy charging function, a network exposure function, or a session management function.

Clause 23: The device of any of clauses 20-22, wherein the one or more processors are further configured to: receive Web Real Time Communication (WebRTC) configuration data from a configuration application function of the one or more application functions; determine interactive connectivity establishment (ICE) and media configuration parameters from the WebRTC configuration data; submit a binding request to one of the STUN server application function or the TURN server application function using the ICE and media configuration parameters; receive binding information in response to the binding request including quality of service (QoS) and codec data; update a session description protocol (SDP) offer or answer according to the received binding information; and initiate a WebRTC media session according to the updated SDP offer or answer.

Clause 24: The device of clause 23, wherein the ICE and media configuration parameters include a list of ICE server application functions that can be used for ICE negotiation and, for each of the ICE server application functions, data representing a type for the ICE server application function, a URL of the ICE server application function, and whether the ICE server application function is 5G-RTC enabled.

Clause 25: The device of any of clauses 20-24, wherein the MSH is configured to receive a list of media configuration recommendations to create a session description protocol (SDP) offer or answer, the list of media configuration recommendations including data representing, for each of the media configuration recommendations, a media type, a codec, an average bitrate, and a maximum bitrate.

Clause 26: A method of exchanging media data, the method comprising: executing a media session handler (MSH) to interact with one or more application functions provided by an application provider device, the one or more application functions including one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function; receiving a web application from the application provider device; and exchanging data between the one or more application functions provided by the application provider device, the MSH, and the web application.

Clause 27: The method of clause 26, wherein exchanging the media data between the one or more application functions, the MSH, and the web application comprises sending or receiving the media data via a Web Real Time Communication (WebRTC) session with the one or more application functions.

Clause 28: The method of any of clauses 26 and 27, wherein the one or more application functions further include one or more of a policy charging function, a network exposure function, or a session management function.

Clause 29: The method of any of clauses 26-28, further comprising: receiving Web Real Time Communication (WebRTC) configuration data from a configuration application function of the one or more application functions; determining interactive connectivity establishment (ICE) and media configuration parameters from the WebRTC configuration data; submitting a binding request to one of the STUN server application function or the TURN server application function using the ICE and media configuration parameters; receiving binding information in response to the binding request including quality of service (QoS) and codec data; updating a session description protocol (SDP) offer or answer according to the received binding information; and initiating a WebRTC media session according to the updated SDP offer or answer.

Clause 30: The method of clause 29, wherein the ICE and media configuration parameters include a list of ICE server application functions that can be used for ICE negotiation and, for each of the ICE server application functions, data representing a type for the ICE server application function, a URL of the ICE server application function, and whether the ICE server application function is 5G-RTC enabled.

Clause 31: The method of any of clauses 26-30, further comprising receiving, by the MSH, a list of media configuration recommendations to create a session description protocol (SDP) offer or answer, the list of media configuration recommendations including data representing, for each of the media configuration recommendations, a media type, a codec, an average bitrate, and a maximum bitrate.

Clause 32: A computer-readable storage medium having stored thereon instructions that, when executed, cause a processor to: execute a media session handler (MSH) to interact with one or more application functions provided by an application provider device, the one or more application functions including one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function; receive a web application from the application provider device; and exchange media data between the one or more application functions provided by the application provider device, the MSH, and the web application.

Clause 33: The computer-readable storage medium of clause 32, wherein the instructions that cause the processor to exchange the media data between the one or more application functions, the MSH, and the web application comprise instructions that cause the processor to send or receive the media data via a Web Real Time Communication (WebRTC) session with the one or more application functions.

Clause 34: The computer-readable storage medium of any of clauses 32 and 33, wherein the one or more application functions further include one or more of a policy charging function, a network exposure function, or a session management function.

Clause 35: The computer-readable storage medium of any of clauses 32-34, further comprising instructions that cause the processor to: receive Web Real Time Communication (WebRTC) configuration data from a configuration application function of the one or more application functions; determine interactive connectivity establishment (ICE) and media configuration parameters from the WebRTC configuration data; submit a binding request to one of the STUN server application function or the TURN server application function using the ICE and media configuration parameters; receive binding information in response to the binding request including quality of service (QoS) and codec data; update a session description protocol (SDP) offer or answer according to the received binding information; and initiate a WebRTC media session according to the updated SDP offer or answer.

Clause 36: The computer-readable storage medium of clause 35, wherein the ICE and media configuration parameters include a list of ICE server application functions that can be used for ICE negotiation and, for each of the ICE server application functions, data representing a type for the ICE server application function, a URL of the ICE server application function, and whether the ICE server application function is 5G-RTC enabled.

Clause 37: The computer-readable storage medium of any of clauses 32-36, further comprising instructions that cause the processor to execute the MSH to receive a list of media configuration recommendations to create a session description protocol (SDP) offer or answer, the list of media configuration recommendations including data representing, for each of the media configuration recommendations, a media type, a codec, an average bitrate, and a maximum bitrate.

Clause 38: A device for exchanging media data, the device comprising: means for executing a media session handler (MSH) to interact with one or more application functions provided by an application provider device, the one or more application functions including one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function; means for receiving a web application from the application provider device; and means for exchanging data between the one or more application functions provided by the application provider device, the MSH, and the web application.

Clause 39: The device of clause 38, wherein the means for exchanging the media data between the one or more application functions, the MSH, and the web application comprises means for sending or receiving the media data via a Web Real Time Communication (WebRTC) session with the one or more application functions.

Clause 40: The device of any of clauses 38 and 39, wherein the one or more application functions further include one or more of a policy charging function, a network exposure function, or a session management function.

Clause 41: The device of any of clauses 38-40, further comprising: means for receiving Web Real Time Communication (WebRTC) configuration data from a configuration application function of the one or more application functions; means for determining interactive connectivity establishment (ICE) and media configuration parameters from the WebRTC configuration data; means for submitting a binding request to one of the STUN server application function or the TURN server application function using the ICE and media configuration parameters; means for receiving binding information in response to the binding request including quality of service (QoS) and codec data; means for updating a session description protocol (SDP) offer or answer according to the received binding information; and means for initiating a WebRTC media session according to the updated SDP offer or answer.

Clause 42: The device of clause 41, wherein the ICE and media configuration parameters include a list of ICE server application functions that can be used for ICE negotiation and, for each of the ICE server application functions, data representing a type for the ICE server application function, a URL of the ICE server application function, and whether the ICE server application function is 5G-RTC enabled.

Clause 43: The device of any of clauses 38-42, further comprising means for executing the MSH to receive a list of media configuration recommendations to create a session description protocol (SDP) offer or answer, the list of media configuration recommendations including data representing, for each of the media configuration recommendations, a media type, a codec, an average bitrate, and a maximum bitrate.

Clause 44: A device for exchanging media data, the device comprising: a memory configured to store media data; and one or more processors implemented in circuitry and configured to: execute a media session handler (MSH) to interact with one or more application functions provided by an application provider device, the one or more application functions including one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function; receive a web application from the application provider device; and exchange media data between the one or more application functions provided by the application provider device, the MSH, and the web application.

Clause 45: The device of clause 44, wherein to exchange the media data between the one or more application functions, the MSH, and the web application, the one or more processors are configured to send or receive the media data via a Web Real Time Communication (WebRTC) session with the one or more application functions.

Clause 46: The device of clause 44, wherein the one or more application functions further include one or more of a policy charging function, a network exposure function, or a session management function.

Clause 47: The device of clause 44, wherein the one or more processors are further configured to: receive Web Real Time Communication (WebRTC) configuration data from a configuration application function of the one or more application functions; determine interactive connectivity establishment (ICE) and media configuration parameters from the WebRTC configuration data; submit a binding request to one of the STUN server application function or the TURN server application function using the ICE and media configuration parameters; receive binding information in response to the binding request including quality of service (QoS) and codec data; update a session description protocol (SDP) offer or answer according to the received binding information; and initiate a WebRTC media session according to the updated SDP offer or answer.

Clause 48: The device of clause 47, wherein the ICE and media configuration parameters include a list of ICE server application functions that can be used for ICE negotiation and, for each of the ICE server application functions, data representing a type for the ICE server application function, a URL of the ICE server application function, and whether the ICE server application function is 5G-RTC enabled.

Clause 49: The device of clause 44, wherein the MSH is configured to receive a list of media configuration recommendations to create a session description protocol (SDP) offer or answer, the list of media configuration recommendations including data representing, for each of the media configuration recommendations, a media type, a codec, an average bitrate, and a maximum bitrate.

Clause 50: A method of exchanging media data, the method comprising: executing a media session handler (MSH) to interact with one or more application functions provided by an application provider device, the one or more application functions including one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function; receiving a web application from the application provider device; and exchanging data between the one or more application functions provided by the application provider device, the MSH, and the web application.

Clause 51: The method of clause 50, wherein exchanging the media data between the one or more application functions, the MSH, and the web application comprises sending or receiving the media data via a Web Real Time Communication (WebRTC) session with the one or more application functions.

Clause 52: The method of clause 50, wherein the one or more application functions further include one or more of a policy charging function, a network exposure function, or a session management function.

Clause 53: The method of clause 50, further comprising: receiving Web Real Time Communication (WebRTC) configuration data from a configuration application function of the one or more application functions; determining interactive connectivity establishment (ICE) and media configuration parameters from the WebRTC configuration data; submitting a binding request to one of the STUN server application function or the TURN server application function using the ICE and media configuration parameters; receiving binding information in response to the binding request including quality of service (QoS) and codec data; updating a session description protocol (SDP) offer or answer according to the received binding information; and initiating a WebRTC media session according to the updated SDP offer or answer.

Clause 54: The method of clause 53, wherein the ICE and media configuration parameters include a list of ICE server application functions that can be used for ICE negotiation and, for each of the ICE server application functions, data representing a type for the ICE server application function, a URL of the ICE server application function, and whether the ICE server application function is 5G-RTC enabled.

Clause 55: The method of clause 50, further comprising receiving, by the MSH, a list of media configuration recommendations to create a session description protocol (SDP) offer or answer, the list of media configuration recommendations including data representing, for each of the media configuration recommendations, a media type, a codec, an average bitrate, and a maximum bitrate.

Clause 56: A computer-readable storage medium having stored thereon instructions that, when executed, cause a processor to: execute a media session handler (MSH) to interact with one or more application functions provided by an application provider device, the one or more application functions including one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function; receive a web application from the application provider device; and exchange media data between the one or more application functions provided by the application provider device, the MSH, and the web application.

Clause 57: The computer-readable storage medium of clause 56, wherein the instructions that cause the processor to exchange the media data between the one or more application functions, the MSH, and the web application comprise instructions that cause the processor to send or receive the media data via a Web Real Time Communication (WebRTC) session with the one or more application functions.

Clause 58: The computer-readable storage medium of clause 56, wherein the one or more application functions further include one or more of a policy charging function, a network exposure function, or a session management function.

Clause 59: The computer-readable storage medium of clause 56, further comprising instructions that cause the processor to: receive Web Real Time Communication (WebRTC) configuration data from a configuration application function of the one or more application functions; determine interactive connectivity establishment (ICE) and media configuration parameters from the WebRTC configuration data; submit a binding request to one of the STUN server application function or the TURN server application function using the ICE and media configuration parameters; receive binding information in response to the binding request including quality of service (QoS) and codec data; update a session description protocol (SDP) offer or answer according to the received binding information; and initiate a WebRTC media session according to the updated SDP offer or answer.

Clause 60: The computer-readable storage medium of clause 59, wherein the ICE and media configuration parameters include a list of ICE server application functions that can be used for ICE negotiation and, for each of the ICE server application functions, data representing a type for the ICE server application function, a URL of the ICE server application function, and whether the ICE server application function is 5G-RTC enabled.

Clause 61: The device of clause 56, further comprising instructions that cause the processor to execute the MSH to receive a list of media configuration recommendations to create a session description protocol (SDP) offer or answer, the list of media configuration recommendations including data representing, for each of the media configuration recommendations, a media type, a codec, an average bitrate, and a maximum bitrate.

Clause 62: A device for exchanging media data, the device comprising: means for executing a media session handler (MSH) to interact with one or more application functions provided by an application provider device, the one or more application functions including one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function; means for receiving a web application from the application provider device; and means for exchanging data between the one or more application functions provided by the application provider device, the MSH, and the web application.

Clause 63: The device of clause 62, wherein the means for exchanging the media data between the one or more application functions, the MSH, and the web application comprises means for sending or receiving the media data via a Web Real Time Communication (WebRTC) session with the one or more application functions.

Clause 64: The device of clause 62, wherein the one or more application functions further include one or more of a policy charging function, a network exposure function, or a session management function.

Clause 65: The device of clause 62, further comprising: means for receiving Web Real Time Communication (WebRTC) configuration data from a configuration application function of the one or more application functions; means for determining interactive connectivity establishment (ICE) and media configuration parameters from the WebRTC configuration data; means for submitting a binding request to one of the STUN server application function or the TURN server application function using the ICE and media configuration parameters; means for receiving binding information in response to the binding request including quality of service (QoS) and codec data; means for updating a session description protocol (SDP) offer or answer according to the received binding information; and means for initiating a WebRTC media session according to the updated SDP offer or answer.

Clause 66: The device of clause 65, wherein the ICE and media configuration parameters include a list of ICE server application functions that can be used for ICE negotiation and, for each of the ICE server application functions, data representing a type for the ICE server application function, a URL of the ICE server application function, and whether the ICE server application function is 5G-RTC enabled.

Clause 67: The device of clause 62, further comprising means for executing the MSH to receive a list of media configuration recommendations to create a session description protocol (SDP) offer or answer, the list of media configuration recommendations including data representing, for each of the media configuration recommendations, a media type, a codec, an average bitrate, and a maximum bitrate.

Clause 68: A device for exchanging media data, the device comprising: a memory configured to store media data; and one or more processors implemented in circuitry and configured to: execute a media session handler (MSH) to interact with one or more application functions provided by an application provider device; and execute an application to: retrieve configuration information from the MSH related to Web Real-Time Communication (WebRTC); and use the configuration information to establish a WebRTC session and exchange media data via the WebRTC session.

Clause 69: The device of clause 68, wherein the one or more application functions include one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function.

Clause 70: The device of clause 68, wherein the one or more application functions include one or more of a policy charging function or a session management function.

Clause 71: The device of clause 68, wherein the one or more processors are further configured to: receive Web Real Time Communication (WebRTC) configuration data from a configuration application function of the one or more application functions; determine interactive connectivity establishment (ICE) and media configuration parameters from the WebRTC configuration data; submit a binding request to one of the STUN server application function or the TURN server application function using the ICE and media configuration parameters; receive binding information in response to the binding request including quality of service (QoS) and codec data; update a session description protocol (SDP) offer or answer according to the received binding information; and initiate a WebRTC media session according to the updated SDP offer or answer.

Clause 72: The device of clause 71, wherein the ICE and media configuration parameters include a list of ICE server application functions that can be used for ICE negotiation and, for each of the ICE server application functions, data representing a type for the ICE server application function, a URL of the ICE server application function, and whether the ICE server application function is 5G-RTC enabled.

Clause 73: The device of clause 71, wherein the binding request is configured to instruct the one of the STUN server application function or the TURN server application function to request QoS allocation from a policy application function.

Clause 74: The device of clause 68, wherein the MSH is configured to receive a list of media configuration recommendations to create a session description protocol (SDP) offer or answer, the list of media configuration recommendations including data representing, for each of the media configuration recommendations, a media type, a codec, an average bitrate, and a maximum bitrate.

Clause 75: A method of exchanging media data, the method comprising: executing a media session handler (MSH) to interact with one or more application functions provided by an application provider device; executing an application to retrieve configuration information from the MSH related to Web Real-Time Communication (WebRTC); and executing the application to use the configuration information to establish a WebRTC session and exchange media data via the WebRTC session.

Clause 76: The method of clause 75, wherein the one or more application functions include one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function.

Clause 77: The method of clause 75, wherein the one or more application functions include one or more of a policy charging function or a session management function.

Clause 78: The method of clause 75, further comprising: receiving Web Real Time Communication (WebRTC) configuration data from a configuration application function of the one or more application functions; determining interactive connectivity establishment (ICE) and media configuration parameters from the WebRTC configuration data; submitting a binding request to one of the STUN server application function or the TURN server application function using the ICE and media configuration parameters; receiving binding information in response to the binding request including quality of service (QoS) and codec data; updating a session description protocol (SDP) offer or answer according to the received binding information; and initiating a WebRTC media session according to the updated SDP offer or answer.

Clause 79: The method of clause 78, wherein the ICE and media configuration parameters include a list of ICE server application functions that can be used for ICE negotiation and, for each of the ICE server application functions, data representing a type for the ICE server application function, a URL of the ICE server application function, and whether the ICE server application function is 5G-RTC enabled.

Clause 80: The method of clause 78, wherein the binding request is configured to instruct the one of the STUN server application function or the TURN server application function to request QoS allocation from a policy application function.

Clause 81: The method of clause 75, further comprising receiving, by the MSH, a list of media configuration recommendations to create a session description protocol (SDP) offer or answer, the list of media configuration recommendations including data representing, for each of the media configuration recommendations, a media type, a codec, an average bitrate, and a maximum bitrate.

Clause 82: A computer-readable storage medium having stored thereon instructions that, when executed, cause a processor to: execute a media session handler (MSH) to interact with one or more application functions provided by an application provider device; execute an application to.

Clause 83: The computer-readable storage medium of clause 82, wherein the one or more application functions including one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function.

Clause 84: The computer-readable storage medium of clause 82, wherein the one or more application functions further include one or more of a policy charging function, a network exposure function, or a session management function.

Clause 85: The computer-readable storage medium of clause 82, further comprising instructions that cause the processor to: receive Web Real Time Communication (WebRTC) configuration data from a configuration application function of the one or more application functions; determine interactive connectivity establishment (ICE) and media configuration parameters from the WebRTC configuration data; submit a binding request to one of the STUN server application function or the TURN server application function using the ICE and media configuration parameters; receive binding information in response to the binding request including quality of service (QoS) and codec data; update a session description protocol (SDP) offer or answer according to the received binding information; and initiate a WebRTC media session according to the updated SDP offer or answer.

Clause 86: The computer-readable storage medium of clause 85, wherein the ICE and media configuration parameters include a list of ICE server application functions that can be used for ICE negotiation and, for each of the ICE server application functions, data representing a type for the ICE server application function, a URL of the ICE server application function, and whether the ICE server application function is 5G-RTC enabled.

Clause 87: The computer-readable storage medium of clause 82, further comprising instructions that cause the processor to execute the MSH to receive a list of media configuration recommendations to create a session description protocol (SDP) offer or answer, the list of media configuration recommendations including data representing, for each of the media configuration recommendations, a media type, a codec, an average bitrate, and a maximum bitrate.

Clause 88: A device for exchanging media data, the device comprising: means for executing a media session handler (MSH) to interact with one or more application functions provided by an application provider device; means for executing an application to retrieve configuration information from the MSH related to Web Real-Time Communication (WebRTC); and means for exchanging data between the one or more application functions provided by the application provider device, the MSH, and the web application.

Clause 89: The device of clause 88, wherein the one or more application functions include one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function.

Clause 90: The device of clause 88, wherein the one or more application functions include one or more of a policy charging function, a network exposure function, or a session management function.

Clause 91: The device of clause 88, further comprising: means for receiving Web Real Time Communication (WebRTC) configuration data from a configuration application function of the one or more application functions; means for determining interactive connectivity establishment (ICE) and media configuration parameters from the WebRTC configuration data; means for submitting a binding request to one of the STUN server application function or the TURN server application function using the ICE and media configuration parameters; means for receiving binding information in response to the binding request including quality of service (QoS) and codec data; means for updating a session description protocol (SDP) offer or answer according to the received binding information; and means for initiating a WebRTC media session according to the updated SDP offer or answer.

Clause 92: The device of clause 91, wherein the ICE and media configuration parameters include a list of ICE server application functions that can be used for ICE negotiation and, for each of the ICE server application functions, data representing a type for the ICE server application function, a URL of the ICE server application function, and whether the ICE server application function is 5G-RTC enabled.

Clause 93: The device of clause 91, wherein the binding request is configured to instruct the one of the STUN server application function or the TURN server application function to request QoS allocation from a policy application function.

Clause 94: The device of clause 88, further comprising means for executing the MSH to receive a list of media configuration recommendations to create a session description protocol (SDP) offer or answer, the list of media configuration recommendations including data representing, for each of the media configuration recommendations, a media type, a codec, an average bitrate, and a maximum bitrate.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for exchanging media data, the device comprising:
a memory configured to store media data; and
one or more processors implemented in circuitry and configured to:
execute a media session handler (MSH) to interact with one or more application functions provided by an application provider device; and
execute an application to:
retrieve configuration information from the MSH related to Web Real-Time Communication (WebRTC); and
use the configuration information to establish a WebRTC session and exchange media data via the WebRTC session.

2. The device of claim 1, wherein the one or more application functions include one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function.

3. The device of claim 1, wherein the one or more application functions include one or more of a policy charging function or a session management function.

4. The device of claim 1, wherein the one or more processors are further configured to:
receive Web Real Time Communication (WebRTC) configuration data from a configuration application function of the one or more application functions;
determine interactive connectivity establishment (ICE) and media configuration parameters from the WebRTC configuration data;
submit a binding request to one of the STUN server application function or the TURN server application function using the ICE and media configuration parameters;
receive binding information in response to the binding request including quality of service (QoS) and codec data;
update a session description protocol (SDP) offer or answer according to the received binding information; and
initiate a WebRTC media session according to the updated SDP offer or answer.

5. The device of claim 4, wherein the ICE and media configuration parameters include a list of ICE server application functions that can be used for ICE negotiation and, for each of the ICE server application functions, data representing a type for the ICE server application function, a URL of the ICE server application function, and whether the ICE server application function is 5G-RTC enabled.

6. The device of claim 4, wherein the binding request is configured to instruct the one of the STUN server application function or the TURN server application function to request QoS allocation from a policy application function.

7. The device of claim 1, wherein the MSH is configured to receive a list of media configuration recommendations to create a session description protocol (SDP) offer or answer, the list of media configuration recommendations including data representing, for each of the media configuration recommendations, a media type, a codec, an average bitrate, and a maximum bitrate.

8. A method of exchanging media data, the method comprising:
executing a media session handler (MSH) to interact with one or more application functions provided by an application provider device;
executing an application to retrieve configuration information from the MSH related to Web Real-Time Communication (WebRTC); and
executing the application to use the configuration information to establish a WebRTC session and exchange media data via the WebRTC session.

9. The method of claim 8, wherein the one or more application functions include one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function.

10. The method of claim 8, wherein the one or more application functions include one or more of a policy charging function or a session management function.

11. The method of claim 8, further comprising:
receiving Web Real Time Communication (WebRTC) configuration data from a configuration application function of the one or more application functions;
determining interactive connectivity establishment (ICE) and media configuration parameters from the WebRTC configuration data;
submitting a binding request to one of the STUN server application function or the TURN server application function using the ICE and media configuration parameters;
receiving binding information in response to the binding request including quality of service (QoS) and codec data;
updating a session description protocol (SDP) offer or answer according to the received binding information; and
initiating a WebRTC media session according to the updated SDP offer or answer.

12. The method of claim 11, wherein the ICE and media configuration parameters include a list of ICE server application functions that can be used for ICE negotiation and, for each of the ICE server application functions, data representing a type for the ICE server application function, a URL of the ICE server application function, and whether the ICE server application function is 5G-RTC enabled.

13. The method of claim 11, wherein the binding request is configured to instruct the one of the STUN server application function or the TURN server application function to request QoS allocation from a policy application function.

14. The method of claim 8, further comprising receiving, by the MSH, a list of media configuration recommendations to create a session description protocol (SDP) offer or answer, the list of media configuration recommendations including data representing, for each of the media configuration recommendations, a media type, a codec, an average bitrate, and a maximum bitrate.

15. A computer-readable storage medium having stored thereon instructions that, when executed, cause a processor to:
execute a media session handler (MSH) to interact with one or more application functions provided by an application provider device;
execute an application to retrieve configuration information from the MSH related to Web Real-Time Communication (WebRTC); and
execute the application to use the configuration information to establish a WebRTC session and exchange media data via the WebRTC session.

16. The computer-readable storage medium of claim 15, wherein the one or more application functions including one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function.

17. The computer-readable storage medium of claim 15, wherein the one or more application functions further include one or more of a policy charging function, a network exposure function, or a session management function.

18. The computer-readable storage medium of claim 15, further comprising instructions that cause the processor to:
receive Web Real Time Communication (WebRTC) configuration data from a configuration application function of the one or more application functions;
determine interactive connectivity establishment (ICE) and media configuration parameters from the WebRTC configuration data;
submit a binding request to one of the STUN server application function or the TURN server application function using the ICE and media configuration parameters;
receive binding information in response to the binding request including quality of service (QoS) and codec data;
update a session description protocol (SDP) offer or answer according to the received binding information; and
initiate a WebRTC media session according to the updated SDP offer or answer.

19. The computer-readable storage medium of claim 18, wherein the ICE and media configuration parameters include a list of ICE server application functions that can be used for ICE negotiation and, for each of the ICE server application functions, data representing a type for the ICE server application function, a URL of the ICE server application function, and whether the ICE server application function is 5G-RTC enabled.

20. The computer-readable storage medium of claim 15, further comprising instructions that cause the processor to execute the MSH to receive a list of media configuration recommendations to create a session description protocol (SDP) offer or answer, the list of media configuration recommendations including data representing, for each of the media configuration recommendations, a media type, a codec, an average bitrate, and a maximum bitrate.

21. A device for exchanging media data, the device comprising:
means for executing a media session handler (MSH) to interact with one or more application functions provided by an application provider device;
means for executing an application to retrieve configuration information from the MSH related to Web Real-Time Communication (WebRTC); and
means for exchanging data between the one or more application functions provided by the application provider device, the MSH, and the web application.

22. The device of claim 21, wherein the one or more application functions include one or more of a support application function, a configuration application function, a provisioning application function, a channel application function, a signaling server application function, an interoperability application function, a Session Traversal Utilities for Network Address Translation (STUN) application function, or a Traversal Using Relay around NAT (TURN) application function.

23. The device of claim 21, wherein the one or more application functions include one or more of a policy charging function, a network exposure function, or a session management function.

24. The device of claim 21, further comprising:
means for receiving Web Real Time Communication (WebRTC) configuration data from a configuration application function of the one or more application functions;
means for determining interactive connectivity establishment (ICE) and media configuration parameters from the WebRTC configuration data;
means for submitting a binding request to one of the STUN server application function or the TURN server application function using the ICE and media configuration parameters;
means for receiving binding information in response to the binding request including quality of service (QoS) and codec data;
means for updating a session description protocol (SDP) offer or answer according to the received binding information; and
means for initiating a WebRTC media session according to the updated SDP offer or answer.

25. The device of claim 24, wherein the ICE and media configuration parameters include a list of ICE server application functions that can be used for ICE negotiation and, for each of the ICE server application functions, data representing a type for the ICE server application function, a URL of the ICE server application function, and whether the ICE server application function is 5G-RTC enabled.

26. The device of claim 24, wherein the binding request is configured to instruct the one of the STUN server application function or the TURN server application function to request QoS allocation from a policy application function.

27. The device of claim 21, further comprising means for executing the MSH to receive a list of media configuration recommendations to create a session description protocol (SDP) offer or answer, the list of media configuration recommendations including data representing, for each of the media configuration recommendations, a media type, a codec, an average bitrate, and a maximum bitrate.
